(19) United States
(12) Patent Application Publication
(10) Pub. No.: US 2026/0122427 A1
(43) Pub. Date: Apr. 30, 2026

(54) SPEAKER AND ELECTRONIC DEVICE

(71) Applicant: Huawei Technologies Co., Ltd., Shenzhen (CN)

(72) Inventors: Haohao Zhang, Dongguan (CN); Rongrong Wu, Shenzhen (CN); Hong Gan, Dongguan (CN); Dongze Wu, Dongguan (CN)

(21) Appl. No.: 19/003,497

(22) Filed: Dec. 27, 2024

Related U.S. Application Data
(63) Continuation of application No. PCT/CN2023/102698, filed on Jun. 27, 2023.

(30) Foreign Application Priority Data
Jun. 30, 2022 (CN) 202210770809.7

(51) Int. Cl. H04R 9/04; H04R 9/02; H04R 9/06

(52) U.S. Cl. CPC H04R 9/046; H04R 9/025; H04R 9/06; H04R 2499/11

(57) ABSTRACT

A speaker that may be used with an electronic device includes a housing, and a diaphragm, a magnet component, and an electromagnetic component. The diaphragm includes a fastening area and a vibration area. The fastening area is connected to the housing, and the vibration area is configured to be excited to generate vibration to produce a sound. The magnet component and the electromagnetic component attract each other through magnetic force. The magnet component is fastened in the vibration area, and the electromagnetic component is fastened in the housing.

### CROSS-REFERENCE TO RELATED APPLICATIONS

This application is a continuation of International Application No. PCT/CN2023/102698, filed on Jun. 27, 2023, which claims priority to Chinese Patent Application No. 202210770809.7, filed on Jun. 30, 2022. The disclosures of the aforementioned applications are hereby incorporated by reference in their entireties.

### TECHNICAL FIELD

This application relates to the field of acoustic technologies, and in particular, to a speaker and an electronic device.

### BACKGROUND

A speaker is a transducer that converts an electrical signal into a sound signal, and is widely used in a plurality of different types of electronic devices. For example, the speaker may be used in an electronic device such as a notebook computer, a mobile phone, or a headset. Performance of the speaker has a great impact on sound quality, and also affects auditory experience of a user. There are many parameters used to evaluate the sound quality of the speaker, for example, a resonance frequency and low-frequency sensitivity. The speaker mainly relies on vibration of a diaphragm to push air to vibrate to produce a sound. When the diaphragm has large stiffness, system stiffness of the speaker is increased. As a result, the speaker has a high resonance frequency and poor low-frequency sensitivity. In addition, with a miniaturization design of an electronic device, a volume of the speaker is continuously decreased. When the volume of the speaker becomes smaller, the system stiffness of the speaker is also increased. Therefore, how to reduce system stiffness of a speaker becomes an urgent technical problem to be resolved.

### SUMMARY

This application provides a speaker and an electronic device that can implement small system stiffness.

According to a first aspect, this application provides a speaker, which may include a housing, a diaphragm, a magnet component, and an electromagnetic component. The housing has an accommodating cavity, and the diaphragm is disposed in the accommodating cavity and divides the accommodating cavity into two cavities: a front cavity and a rear cavity. The diaphragm includes a fastening area and a vibration area. The fastening area is fixedly connected to the housing, and the vibration area is configured to be excited to generate vibration, to push surrounding air to produce a sound. The vibration area is connected to the fastening area through a folding ear. When the vibration area is excited to generate vibration displacement, the folding ear can provide elastic recovery force, to drive the vibration area to recover to an initial location. The initial location of the vibration area is a location at which the vibration displacement of the vibration area is zero. The magnet component and the electromagnetic component attract each other through magnetic force. The magnet component is fastened in the vibration area, and the electromagnetic component is fastened in the housing. When the vibration area of the diaphragm is at the initial location (that is, the vibration displacement is zero), acting force applied by the magnet component and the electromagnetic component to the vibration area is zero. In a process in which the vibration area vibrates (that is, when the vibration displacement is not zero), acting force applied by the magnet component and the electromagnetic component to the vibration area is the same as a vibration displacement direction of the vibration area. The vibration displacement direction of the vibration area is a direction in which the initial location of the vibration area points to a vibration location of the vibration area. The vibration location of the vibration area may be understood as a location at which the vibration area is located at a moment when the vibration area vibrates. For example, the vibration area vibrates to an upward location that deviates from the initial location. The above-mentioned acting force applied by the magnet component and the electromagnetic component to the vibration area does not include acting force used to drive the vibration area to vibrate to produce a sound. Alternatively, it may be understood that the acting force does not include force generated when an alternating current is input into the electromagnetic component.

In the speaker provided in this embodiment of this application, the electromagnetic component may interact with the magnet component through magnetic field force, to provide negative stiffness for a component of the speaker, thereby reducing system stiffness of the component of the speaker. In addition, after an alternating current is input into the electromagnetic component, the electromagnetic component may interact with the magnet component through the magnetic field force, to excite the vibration area of the diaphragm to vibrate to produce a sound. In addition, in actual application, because the electromagnetic component is fastened in the housing, heat generated by the electromagnetic component may be effectively transferred to the housing, thereby helping improve heat dissipation effect of the electromagnetic component.

In an example, the magnet component may be a permanent magnet. Specifically, the magnet component may include an entire permanent magnet or may include at least two permanent magnets.

For example, the magnet component may be a ring-shaped permanent magnet, and a pole direction of the magnet component may be consistent with a radial direction of the magnet component, thereby helping improve stability of magnetic force between the magnet component and the electromagnetic component.

Certainly, in another example, a shape of the magnet component may alternatively be a strip shape, a circular sheet shape, an elliptical ring shape, or the like. Details are not described herein.

In an example, the electromagnetic component may include a coil and a magnetic core. The magnetic core may be located in a magnetic circuit of the coil, and is configured to enhance or guide a magnetic field generated by the coil, to ensure acting force between the electromagnetic component and the magnet component.

In actual application, when the vibration area is at the initial location, a sum of magnetic force between the magnet component and the magnetic core may be zero. To be specific, when the electromagnetic component is not powered on, a sum of magnetic force between the magnet component and the magnetic core in the electromagnetic component may be zero.

Alternatively, there may be a correction current in the coil, and when the vibration area is at the initial location, a sum of magnetic force between the electromagnetic component and the magnet component is zero. For example, some components in the speaker may have a manufacturing precision error or an assembly error. As a result, when the vibration displacement of the vibration area is zero, resultant force generated by the magnet component and the magnetic core on the diaphragm is not zero, and consequently the folding ear is elastically deformed. When the diaphragm is excited to generate vibration, a problem of force imbalance occurs between a first vibration displacement direction and a second vibration displacement direction, affecting sound quality performance of the speaker. Therefore, a correction current may be input into the electromagnetic component. After the correction current is input into the electromagnetic component, a correction magnetic field can be generated, so that when the vibration displacement of the vibration area is zero, the folding ear is not elastically deformed.

During specific application, the speaker may further include a control circuit, and the control circuit may be in signal connection to the electromagnetic component, to effectively control a current in the electromagnetic component. It should be noted that, the current may be a correction current, may be an alternating current used to enable the diaphragm vibrate to produce a sound, or may be superposition of a correction current and an alternating current.

In an example, the coil may include a first coil and a second coil, the magnetic core may include a first magnetic core and a second magnetic core, the first magnetic core may be located in a magnetic circuit of the first coil, and the second magnetic core may be located in a magnetic circuit of the second coil.

During specific disposing, the first coil and the first magnetic core are located in the first vibration displacement direction of the vibration area, and the second coil and the second magnetic core are located in the second vibration displacement direction of the vibration area. The first vibration displacement direction is opposite to the second vibration displacement direction.

In an example, the first magnetic core may include a first inner core and a first outer core, the first inner core may be located in an inner ring of the first coil, and the first outer core may be located in an outer ring of the first coil, so that the first magnetic core can effectively enhance or guide a magnetic field generated by the first coil.

In an example, the second magnetic core may include a second inner core and a second outer core, the second inner core may be located in an inner ring of the second coil, and the second outer core may be located in an outer ring of the second coil, so that the second magnetic core can effectively enhance or guide a magnetic field generated by the second coil.

During specific implementation, the coil and the magnetic core may be located on a same plane, and the plane is parallel to the diaphragm, so that space occupation (that is, a height size) of the coil and the magnetic core in a vibration displacement direction of the vibrated vibration area can be effectively reduced, thereby helping reduce a height size of the entire speaker.

Alternatively, in an example, the magnet component may be fastened in the vibration area, and the electromagnetic component may be fastened in the housing. The magnetic core may include a first magnetic core and a second magnetic core, and the coil may include a first coil, a second coil, a third coil, and a fourth coil.

The first magnetic core may be U-shaped, and the first coil and the second coil are respectively wound on two opposite cantilevers of the first magnetic core. The second magnetic core may be U-shaped, and the third coil and the fourth coil are respectively wound on two opposite cantilevers of the second magnetic core. The first magnetic core is located on a first side edge of the diaphragm, and the second magnetic core is located on a second side edge of the diaphragm. The first side edge and the second side edge are away from each other, and U-shaped openings of the first magnetic core and the second magnetic core are disposed opposite to each other, thereby helping reduce a height size of the speaker.

During specific disposing, projections of the first coil, the second coil, the third coil, and the fourth coil on a plane on which the diaphragm is located do not overlap the diaphragm. This helps ensure maximum vibration displacement of the diaphragm, and also helps effectively reduce a height size of the speaker.

Alternatively, in an example, locations of the magnet component and the electromagnetic component may be interchanged.

For example, another speaker provided in this application may include a housing, a diaphragm, a magnet component, and an electromagnetic component. The housing has an accommodating cavity, and the diaphragm is disposed in the accommodating cavity and divides the accommodating cavity into two cavities: a front cavity and a rear cavity. The diaphragm includes a fastening area and a vibration area. The fastening area is fixedly connected to the housing, and the vibration area is configured to be excited to generate vibration, to push surrounding air to produce a sound. The vibration area is connected to the fastening area through a folding ear. When the vibration area is excited to generate vibration displacement, the folding ear can provide elastic recovery force, to drive the vibration area to recover to an initial location. The initial location of the vibration area is a location at which the vibration displacement of the vibration area is zero. The magnet component and the electromagnetic component attract each other through magnetic force. The electromagnetic component is fastened in the vibration area, and the magnet component is fastened in the housing. When the vibration area of the diaphragm is at the initial location (that is, the vibration displacement is zero), acting force applied by the magnet component and the electromagnetic component to the vibration area is zero. In a process in which the vibration area vibrates (that is, when the vibration displacement is not zero), acting force applied by the magnet component and the electromagnetic component to the vibration area is the same as a vibration displacement direction of the vibration area. The vibration displacement direction of the vibration area is a direction in which the initial location of the vibration area points to a vibration location of the vibration area. The vibration location of the vibration area may be understood as a location at which the vibration area is located at a moment when the vibration area vibrates. For example, the vibration area vibrates to an upward location that deviates from the initial location. The above-mentioned acting force applied by the magnet component and the electromagnetic component to the vibration area does not include acting force used to drive the vibration area to vibrate to produce a sound. Alternatively, it may be understood that the acting force does not include force generated when an alternating current is input into the electromagnetic component.

In the speaker provided in this embodiment of this application, the electromagnetic component may interact with the magnet component through magnetic field force, to provide negative stiffness for a component of the speaker, thereby reducing system stiffness of the component of the speaker. In addition, after an alternating current is input into the electromagnetic component, the electromagnetic component may interact with the magnet component through the magnetic field force, to excite the vibration area of the diaphragm to vibrate to produce a sound.

In an example, the magnet component may be a permanent magnet. Specifically, the magnet component may include an entire permanent magnet or may include at least two permanent magnets.

For example, the magnet component may be a ring-shaped permanent magnet, and a pole direction of the magnet component may be consistent with a radial direction of the magnet component, thereby helping improve stability of magnetic force between the magnet component and the electromagnetic component.

Certainly, in another example, a shape of the magnet component may alternatively be a strip shape, a circular sheet shape, an elliptical ring shape, or the like. Details are not described herein.

In an example, the electromagnetic component may include a coil and a magnetic core. The magnetic core may be located in a magnetic circuit of the coil, and is configured to enhance or guide a magnetic field generated by the coil, to ensure acting force between the electromagnetic component and the magnet component.

In actual application, when the vibration area is at the initial location, a sum of magnetic force between the magnet component and the magnetic core may be zero. To be specific, when the electromagnetic component is not powered on, a sum of magnetic force between the magnet component and the magnetic core in the electromagnetic component may be zero.

Alternatively, there may be a correction current in the coil, and when the vibration area is at the initial location, a sum of magnetic force between the electromagnetic component and the magnet component is zero. For example, some components in the speaker may have a manufacturing precision error or an assembly error. As a result, when the vibration displacement of the vibration area is zero, resultant force generated by the magnet component and the magnetic core on the diaphragm is not zero, and consequently the folding ear is elastically deformed. When the diaphragm is excited to generate vibration, a problem of force imbalance occurs between a first vibration displacement direction and a second vibration displacement direction, affecting sound quality performance of the speaker. Therefore, a correction current may be input into the electromagnetic component. After the correction current is input into the electromagnetic component, a correction magnetic field can be generated, so that when the vibration displacement of the vibration area is zero, the folding ear is not elastically deformed.

During specific application, the speaker may further include a control circuit, and the control circuit may be in signal connection to the electromagnetic component, to effectively control a current in the electromagnetic component. It should be noted that, the current may be a correction current, may be an alternating current used to enable the diaphragm vibrate to produce a sound, or may be superposition of a correction current and an alternating current.

In an example, the magnet component may include a first permanent magnet and a second permanent magnet, the first permanent magnet is located in the first vibration displacement direction of the vibration area, and the second permanent magnet is located in the second vibration displacement direction of the vibration area. The first vibration displacement direction is opposite to the second vibration displacement direction.

During specific implementation, the coil and the magnetic core may be located on a same plane, and the plane is parallel to the diaphragm, so that space occupation (that is, a height size) of the coil and the magnetic core in a vibration displacement direction of the vibrated vibration area can be effectively reduced, thereby helping reduce a height size of the entire speaker.

During specific disposing, disposing locations of the magnet component and the electromagnetic component may be adaptively adjusted based on different requirements, and therefore there is good flexibility.

According to a second aspect, this application further provides an electronic device, which may include a controller and any one of the foregoing speakers. The controller may be in signal connection to the electromagnetic component in the speaker, to effectively control a current that is input into the electromagnetic component.

The electronic device may be a mobile phone, a tablet computer, a sound box, a headset, or the like. A specific type of the electronic device is not limited in this application.

### BRIEF DESCRIPTION OF THE DRAWINGS

FIG. 1 is a diagram of a three-dimensional structure of a mobile phone according to an embodiment of this application;

FIG. 2 is a diagram of an audio signal processing process according to an embodiment of this application;

FIG. 3 is a sectional view of a partial structure of a moving coil speaker;

FIG. 4 is a diagram of a three-dimensional structure of a speaker according to an embodiment of this application;

FIG. 5 is a diagram of a cross-sectional structure taken along a surface A in FIG. 4;

FIG. 6 is a diagram of frequency response data of a speaker according to an embodiment of this application;

FIG. 7 is a diagram of an exploded structure of a speaker according to an embodiment of this application;

FIG. 8 is a data diagram illustrating that acting force applied by an electromagnetic component and a magnet component to a vibration area varies with vibration displacement of the vibration area according to an embodiment of this application;

FIG. 9 is a data diagram illustrating that negative stiffness of an electromagnetic component and a magnet component varies with vibration displacement of a vibration area according to an embodiment of this application;

FIG. 10 is a data diagram illustrating that force applied to a vibration area varies with vibration displacement according to an embodiment of this application;

FIG. 11 is a data diagram illustrating that acting force applied by an electromagnetic component and a magnet component to a vibration area varies with vibration displacement of the vibration area in a case of different input power of the electromagnetic component according to an embodiment of this application;

FIG. 12 is a diagram of a cross-sectional structure of a speaker according to an embodiment of this application;

FIG. 13 is a diagram of a planar structure of a magnet component according to an embodiment of this application;

FIG. 14 is a diagram of a cross-sectional structure of another speaker according to an embodiment of this application;

FIG. 15 is a diagram of an exploded structure of another speaker according to an embodiment of this application;

FIG. 16 is a diagram of a three-dimensional structure of a partial structure of a speaker according to an embodiment of this application;

FIG. 17 is a data diagram illustrating that acting force applied by an electromagnetic component and a magnet component to a vibration area varies with vibration displacement of the vibration area according to an embodiment of this application; and

FIG. 18 is a diagram of a structure of an electronic device according to an embodiment of this application.

### DETAILED DESCRIPTION OF ILLUSTRATIVE EMBODIMENTS

To make the objectives, technical solutions, and advantages of this application clearer, the following further describes this application in detail with reference to the accompanying drawings.

To facilitate understanding of the speaker provided in embodiments of this application, the following first describes an application scenario of the speaker.

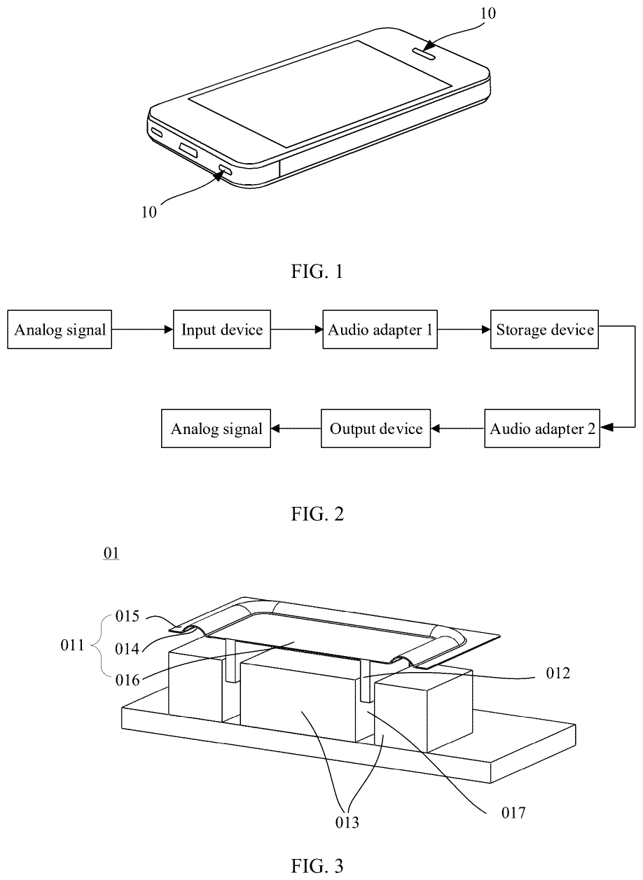

FIG. 1 is a diagram of a three-dimensional structure of a mobile phone. The speaker may be used in the mobile phone. Specifically, the speaker may be disposed at a location such as a top of the mobile phone or a bottom of the mobile phone. Certainly, in actual application, the speaker may alternatively be used in an electronic device such as a tablet computer, a sound box, a headset, or a television. A specific application scenario of the speaker is not limited in this application.

A speaker is an electro-acoustic transducer that can convert an electrical signal into a sound signal for playing.

FIG. 2 shows an audio signal processing process.

An analog signal (for example, a human voice or a natural sound wave) may be recorded by using an input device (for example, a microphone), and the analog signal is converted into an electrical signal by using an audio adapter 1. Finally, the electrical signal may be stored in a storage device as an audio file.

Further, the electrical signal may be converted into an analog signal by using an audio adapter 2, and converted into an analog signal by using an output device (for example, a speaker) for playing.

In actual application, when distinguishing is performed based on different driving force, speakers may be classified into a moving coil type, a moving iron type, a piezoelectric type, an electrostatic type, and the like. However, sound production principles of different types of speakers all are producing a sound by pushing nearby air to vibrate through diaphragm vibration.

FIG. 3 is a sectional view of a partial structure of a moving coil speaker 01. The speaker 01 may include a diaphragm 011, a coil 012, and a permanent magnet 013. The diaphragm 011 has a folding ear 014, and the folding ear 014 divides the diaphragm into an edge area 015 for fastening and a middle area 016 for vibration. The edge area 015 of the diaphragm 011 is usually fixedly connected to a housing (not shown in FIG. 3) of the speaker 01, and the coil 012 is fastened on a surface of the middle area 016. The coil 012 is located in a magnetic gap 017 of the permanent magnet 013. When an alternating current is input into the coil 012, under action of Lorentz force, the coil 012 drives the middle area 016 of the diaphragm 011 to vibrate to produce a sound.

The following vibration equation of the diaphragm 011 may be obtained by performing force analysis on the diaphragm 011:

$${F}_{m} sin ω t = {M}_{m s} \frac{{d}^{2} x}{d {t}^{2}} + {R}_{m s} \frac{d x}{d t} + {K}_{m s} ( x ) x \qquad ( 1 )$$

In the speaker 01, a vibration component such as the middle area 016 of the diaphragm 011 may be referred to as a vibration system, and the folding ear 014, the edge area 015, and the like may be referred to as support systems. In the vibration system, a weight of a part participating in vibration and equivalent sound quality generated under action of sound radiation and reflection are collectively referred to as a vibration weight Mms of the speaker 01. When the middle area 016 of the diaphragm 011 vibrates and deviates from an initial location (or a location at which vibration displacement is not zero), the support system such as the folding ear 014 generates elastic recovery force for the middle area 016. The elastic recovery force varies with vibration displacement of the middle area 016, and system stiffness Kms of the speaker 01 may be obtained. The vibration mass Mms and the system stiffness Kms determine a first-order resonance frequency of the vibration system of the speaker 01. The first-order resonance frequency fs is defined as:

$${f}_{s} = \frac{1}{2 π} \sqrt{\frac{{K}_{m s}}{{M}_{m s}}} \qquad ( 2 )$$

It can be learned from the foregoing formula that, smaller system stiffness Kms and larger vibration mass Mms help reduce the first-order resonance frequency fs, so that the speaker 01 can obtain higher low-frequency output performance.

The system stiffness Kms of the speaker 01 mainly includes two aspects. One aspect is a size of a rear cavity of the speaker, that is, air stiffness Kb. Generally, a larger rear cavity indicates lower air stiffness Kb, and on the contrary, a smaller rear cavity indicates higher air stiffness Kb. The other aspect is stiffness Ks of the folding ear 014 or another support system, and the stiffness is related to a Young's modulus, a thickness, and a structural design of a material of the folding ear 014.

Because Kms=Kb+Ks, a larger rear cavity of the speaker 01 is more helpful to reduce the system stiffness Kms. However, with miniaturization of an electronic device, a volume of the speaker 01 becomes increasingly smaller. Therefore, the rear cavity is increasingly smaller, and it is difficult to further reduce the air stiffness Kb. For the stiffness Ks of the support system, due to constraints of a material technology, a series of reliability problems and nonlinear problems are caused if the stiffness is further reduced. Therefore, based on a current material technology, it is difficult to further optimize the stiffness Ks of the support system.

When the middle area 016 of the diaphragm 011 vibrates and deviates from the initial location, the support system such as the folding ear 014 generates the elastic recovery force for the middle area 016, and the elastic recovery force varies with the vibration displacement of the middle area 016. Therefore, theoretically, the system stiffness Kms can be reduced by introducing force that offsets the recovery force, thereby reducing the first-order resonance frequency fs.

Therefore, the following vibration equation of the diaphragm 011 may be obtained by performing force analysis on the diaphragm 011:

$${F}_{m} sin ω t = {M}_{m s} \frac{{d}^{2} x}{d {t}^{2}} + {R}_{m s} \frac{d x}{d t} + {K}_{m s} ( x ) x - {F}_{m a g} ( x ) \qquad ( 3 )$$

It can be learned from comparison between formula (1) and formula (3) that, force Fmag(x) that offsets the recovery force is introduced into formula (3), that is:

$${F}_{m a g} ( x ) = {K}_{b} ( x ) x \qquad ( 4 )$$

The following may be obtained through deduction by using formula (3) and formula (4):

$${F}_{m} sin ω t = {M}_{m s} \frac{{d}^{2} x}{d {t}^{2}} + {R}_{m s} \frac{d x}{d t} + ( {K}_{m s} ( x ) - {K}_{b} ( x ) ) x \qquad ( 5 )$$

$$K = {K}_{m s} ( x ) x - {K}_{b} ( x ) \qquad ( 6 )$$

K represents new system stiffness, and Kb represents introduced negative stiffness.

In the speaker provided in this application, a mechanism that can generate negative stiffness is introduced, so that system stiffness of the speaker can be effectively reduced, thereby helping reduce a resonance frequency of the speaker, improve low-frequency sensitivity, and so on.

To make the objectives, technical solutions, and advantages of this application clearer, the following further describes this application in detail with reference to the accompanying drawings and specific embodiments.

Terms used in the following embodiments are merely intended to describe specific embodiments, but are not intended to limit this application. As used in the specification and the appended claims of this application, singular expressions “one”, “a”, and “the” are also intended to include an expression such as “one or more”, unless opposite indication is explicitly described in the context. It should be further understood that, in the following embodiments of this application, “at least one” means one, two, or more.

Reference to “an embodiment” or the like described in this specification indicates that one or more embodiments of this application include a specific feature, structure, or characteristic described with reference to the embodiment. Therefore, statements such as “in an embodiment”, “in some implementations”, and “in other implementations” that appear at different places in the specification do not necessarily mean referring to a same embodiment. Instead, the statements mean “one or more but not all of embodiments”, unless otherwise specifically emphasized in another manner. Terms “include”, “have”, and variants thereof all mean “include but are not limited to”, unless otherwise specifically emphasized in another manner.

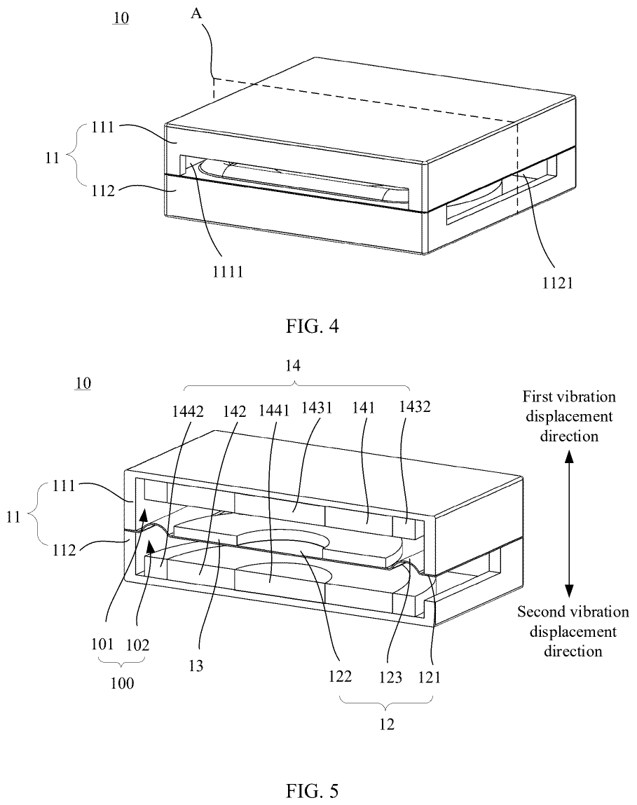

As shown in FIG. 4 and FIG. 5, in an example provided in this application, a speaker 10 may include a housing 11, a diaphragm 12, a magnet component 13, and an electromagnetic component 14. The magnet component 13 and the electromagnetic component 14 may be understood as introduced mechanisms that can generate negative stiffness. In addition, a magnetic field for interaction between the magnet component 13 and the electromagnetic component 14 can further excite the diaphragm 12 to vibrate to produce a sound. Specifically, the housing 11 has an accommodating cavity 100, and the diaphragm 12 is disposed in the accommodating cavity 100 and divides the accommodating cavity 100 into two cavities: a front cavity 101 and a rear cavity 102. The diaphragm 12 includes a fastening area 121 and a vibration area 122. The fastening area 121 is fixedly connected to the housing 11, and the vibration area 122 is configured to be excited to generate vibration, to push surrounding air to produce a sound. The vibration area 122 is connected to the fastening area 121 through a folding ear 123. When the vibration area 122 is excited to generate vibration displacement, the folding ear 123 can provide elastic recovery force, to drive the vibration area 122 to recover to an initial location. The initial location of the vibration area 122 is a location at which the vibration displacement of the vibration area 122 is zero. The magnet component 13 and the electromagnetic component 14 attract each other through magnetic force. The magnet component 13 is fastened in the vibration area 122, and the electromagnetic component 14 is fastened in the housing 11. When the vibration area 122 of the diaphragm 12 is at the initial location (that is, the vibration displacement is zero), acting force applied by the magnet component 13 and the electromagnetic component 14 to the vibration area 122 is zero. In a process in which the vibration area 122 vibrates (that is, when the vibration displacement is not zero), acting force applied by the magnet component 13 and the electromagnetic component 14 to the vibration area 122 is the same as a vibration displacement direction of the vibration area 122. The vibration displacement direction of the vibration area 122 is a direction in which the initial location of the vibration area 122 points to a vibration location of the vibration area 122. The vibration location of the vibration area may be understood as a location at which the vibration area is located at a moment when the vibration area vibrates. For example, the vibration area vibrates to an upward location that deviates from the initial location.

For example, when the diaphragm 12 is excited to generate vibration, the vibration area 122 may generate vibration displacement in a first vibration displacement direction or a second vibration displacement direction. When the vibration displacement of the vibration area 122 is zero, the folding ear 123 is not elastically deformed. Therefore, the folding ear 123 does not generate recovery force for the vibration area 122. In addition, magnetic force generated by the electromagnetic component 14 for the magnet component 13 is zero. Therefore, external force generated by the electromagnetic component 14 and the magnet component 13 for the vibration area 122 is zero. After the vibration area 122 has displacement in the first vibration displacement direction, the folding ear 123 generates recovery force in the second vibration displacement direction for the vibration area 122, to drive the vibration area 122 to recover to a location at which the vibration displacement is zero. In addition, the electromagnetic component 14 generates magnetic force in the first vibration displacement direction for the magnet component 13, to drive the vibration area 122 to generate displacement in the first vibration displacement direction, so that a part of the recovery force generated by the folding ear 123 can be offset, thereby reducing system stiffness of the speaker 10. Alternatively, it may be understood that, in a process in which the vibration area 122 of the diaphragm 12 vibrates, a direction of resultant force applied by the electromagnetic component 14 and the magnet component 13 is always the same as a direction in which the vibration area 122 leaves the initial location, or the direction of the resultant force applied by the electromagnetic component 14 and the magnet component 13 is always opposite to a direction in which the vibration area 122 faces the initial location, and the resultant force can offset a part of the recovery force generated by the folding ear 123, thereby reducing system stiffness of the speaker 10.

In actual application, an alternating current may be input into the electromagnetic component 14, so that the electromagnetic component 14 generates an alternating magnetic field. A magnetic field of the magnet component 13 interacts with the alternating magnetic field generated by the electromagnetic component 14, so that the vibration area 122 is excited to generate vibration. In other words, in the speaker 10 provided in this embodiment of this application, the electromagnetic component 14 may interact with the magnet component 13 through magnetic field force, to provide negative stiffness for a component of the speaker 10, thereby reducing system stiffness of the component of the speaker 10. In addition, after an alternating current is input into the electromagnetic component 14, the electromagnetic component 14 may interact with the magnet component 13 through the magnetic field force, to excite the vibration area 122 of the diaphragm 12 to vibrate to produce a sound. In addition, in actual application, because the electromagnetic component 14 is fastened in the housing 11, heat generated by the electromagnetic component 14 may be effectively transferred to the housing 11, thereby helping improve heat dissipation effect of the electromagnetic component 14.

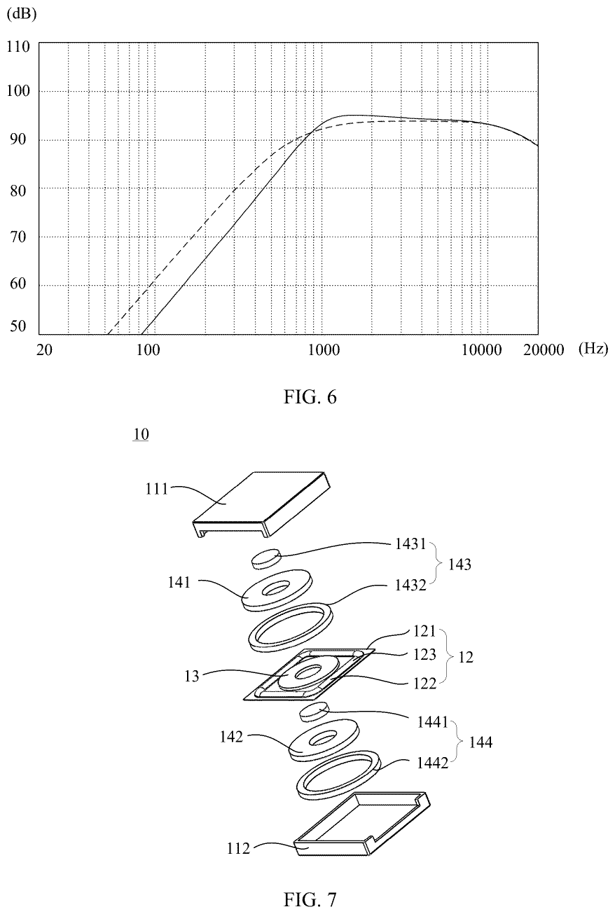

As shown in FIG. 6, an embodiment of this application further provides a diagram of comparison between frequency responses of different speakers.

In FIG. 6, a horizontal coordinate is a frequency in units of Hz, and a vertical coordinate is a sound pressure value in units of dB. A solid line represents a frequency response curve of a conventional speaker, and a dashed line represents a frequency response curve of the speaker provided in this embodiment of this application. It can be clearly learned from comparison that, the speaker provided in this embodiment of this application has a lower resonance frequency and better low-frequency sensitivity.

In addition, it should be noted that, that the magnet component 13 and the electromagnetic component 14 magnetically attract each other means the following: When a direct current or an alternating current is input into the electromagnetic component 14, acting force for mutual magnetic attraction exists between the magnet component 13 and the electromagnetic component 14; or when no current or an alternating current is input into the electromagnetic component 14, acting force for mutual magnetic attraction exists between the magnet component 13 and the electromagnetic component 14. Specifically, when no current is input or a direct current is input, the magnet component 13 and the electromagnetic component 14 may generate magnetic attraction force; and when an alternating current is input, in addition to the magnetic attraction force, force that enables the diaphragm 12 to vibrate can be further generated, to produce a sound. For example, the magnet component 13 may be a permanent magnet, and the electromagnetic component 14 may include a coil and a magnetic core. The magnetic core can be attracted by the permanent magnet. Therefore, when no current is input into the coil, magnetic attraction force exists between the permanent magnet and the magnetic core. After a current is input into the coil, a magnetic field attracted to the magnet component 13 is generated. The magnetic core may be located in a magnetic circuit of the coil, and is configured to enhance or guide the magnetic field. The magnetic circuit of the coil may be understood as an area in which magnetic induction lines are dense in the magnetic field generated by the coil. The magnetic core has good magnetic permeability, which can increase magnetic induction intensity and magnetic flux density of the coil, so that the electromagnetic component 14 can generate large magnetic force. In actual application, the magnetic core may be formed by sintering a plurality of iron oxide mixtures. A specific material of the magnetic core is not limited in this application.

During specific application, the speaker 10 may have various structure types.

As shown in FIG. 4 and FIG. 5, when the housing 11 is disposed, appearance of the housing 11 is approximately in a shape of a rectangular block. Specifically, the housing 11 may include an upper cover 111 and a lower cover 112 that are mutually buckled. The diaphragm 12 is fastened between the upper cover 111 and the lower cover 112. Specifically, shape contours of an edge of the upper cover 111, an edge of the lower cover 112, and the fastening area 121 of the diaphragm 12 are approximately the same. After the upper cover 111 and the lower cover 112 are fixedly connected, the fastening area 121 is fastened between the upper cover 111 and the lower cover 112 through clamping. A side wall of the upper cover 111 has a notch 1111, and a side wall of the lower cover 112 has a notch 1121. In actual application, the notch 1111 may be used as a sound output hole of the speaker 10, and the notch 1121 may be used as a ventilation hole of the rear cavity. It may be understood that, in another implementation, the housing 11 may alternatively be of another shape structure. This is not limited in this application.

In addition, in some implementations, at least some areas of the housing 11 may be made of a magnetic material, so that a magnetic field generated by the electromagnetic component 14 can be effectively enhanced or guided. For example, an area in which the electromagnetic component 14 is vertically projected onto the housing 11 may be made of a magnetic material. Another area of the housing 11 may be made of a material such as plastic or metal. Alternatively, the entire housing 11 may be made of a magnetic material. Certainly, when the housing 11 is specifically disposed, materials of different areas of the housing 11 may be properly selected based on an actual situation, so that the housing 11 can effectively consider both heat dissipation performance and magnetic permeability. Details are not described herein.

In addition, as shown in FIG. 5 and FIG. 7, when the electromagnetic component 14 is disposed, the electromagnetic component 14 includes two coils and two magnetic cores. Specifically, the two coils are respectively a first coil 141 and a second coil 142, and the two magnetic cores are respectively a first magnetic core 143 and a second magnetic core 144. The first magnetic core 143 is located in a magnetic circuit of the first coil 141, and the second magnetic core 144 is located in a magnetic circuit of the second coil 142. The first coil 141 and the first magnetic core 143 are located in the first vibration displacement direction of the vibration area 122. The second coil 142 and the second magnetic core 144 are located in the second vibration displacement direction of the vibration area 122. Alternatively, it may be understood that, the first coil 141 and the second coil 142 are disposed symmetrically around the magnet component 13, and the first magnetic core 143 and the second magnetic core 144 are disposed symmetrically around the magnet component 13.

When the vibration displacement of the vibration area 122 is zero, magnetic attraction force generated by the first coil 141 and the first magnetic core 143 for the magnet component 13 is F1, and magnetic attraction force generated by the second coil 142 and the second magnetic core 144 for the magnet component 13 is F2. F1 and F2 are almost the same in magnitude, and are opposite in direction, that is, resultant force of F1 and F2 is almost zero. After the vibration area 122 generates vibration displacement towards the first vibration displacement direction, the magnet component 13 generates displacement towards the first vibration displacement direction, so that the magnet component 13 is closer to the first coil 141 and the first magnetic core 143, and is away from the second coil 142 and the second magnetic core 144. Therefore, F1 increases, and F2 decreases, that is, a direction of the resultant force of F1 and F2 is consistent with the first vibration displacement direction. Correspondingly, after the vibration area 122 generates vibration displacement towards the second vibration displacement direction, the magnet component 13 generates displacement towards the second vibration displacement direction, so that F1 decreases, and F2 increases, that is, the direction of the resultant force of F1 and F2 is consistent with the second vibration displacement direction. In summary, when the vibration displacement of the vibration area 122 is zero, a sum of magnetic force generated by the electromagnetic component 14 for the magnet component 13 is zero; and when the vibration displacement of the vibration area 122 is not zero, a direction of the magnetic force generated by the electromagnetic component 14 for the magnet component 13 is consistent with a vibration displacement direction of the vibration area 122. In addition, larger vibration displacement of the vibration area 122 indicates larger magnetic force generated by the electromagnetic component 14 for the magnet component 13.

For example, as shown in FIG. 8, an embodiment of this application further provides a data diagram illustrating that resultant force of F1 and F2 varies with vibration displacement of the vibration area 122. In FIG. 8, a horizontal coordinate represents the vibration displacement of the vibration area 122, and the vibration displacement is in units of mm. When the vibration displacement is greater than zero, it indicates that the vibration area 122 generates vibration displacement towards the first vibration displacement direction; and when the vibration displacement is less than zero, it indicates that the vibration area 122 generates vibration displacement towards the second vibration displacement direction. A vertical coordinate represents electromagnetic force generated by the electromagnetic component 14 for the magnet component 13, and the electromagnetic force is in units of N. When the electromagnetic force is greater than zero, it indicates that a direction of the resultant force of F1 and F2 is consistent with the first vibration displacement direction; and when the electromagnetic force is less than zero, it indicates that the direction of the resultant force of F1 and F2 is consistent with the second vibration displacement direction.

It can be learned from the figure that, when the vibration displacement of the vibration area 122 is zero, magnetic attraction force between the electromagnetic component 14 and the magnet component 13 is zero; and when the vibration displacement of the vibration area 122 increases, the magnetic attraction force between the electromagnetic component 14 and the magnet component 13 significantly increases.

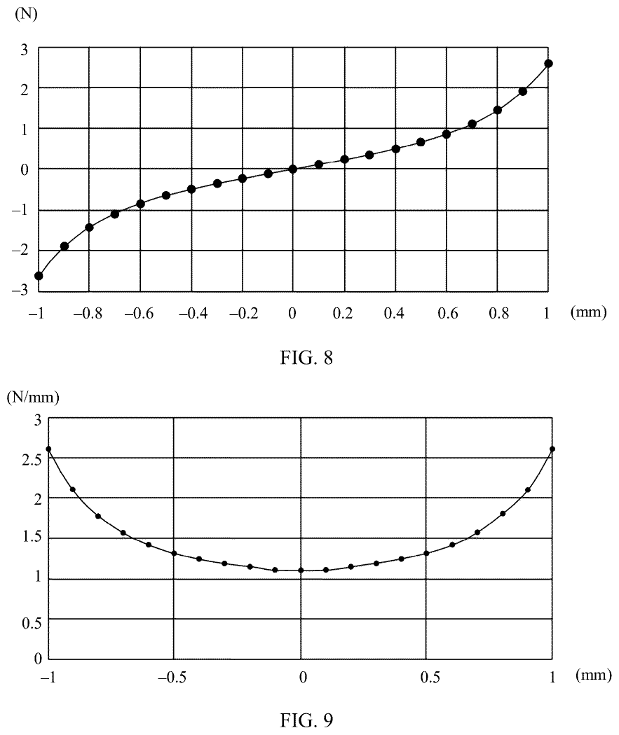

In addition, FIG. 9 further provides a data diagram illustrating that negative stiffness of the electromagnetic component 14 and the magnet component 13 varies with vibration displacement of the vibration area 122. In FIG. 9, a horizontal coordinate represents the vibration displacement of the vibration area 122, and the vibration displacement is in units of mm. When the vibration displacement is greater than zero, it indicates that the vibration area 122 generates vibration displacement towards the first vibration displacement direction; and when the vibration displacement is less than zero, it indicates that the vibration area 122 generates vibration displacement towards the second vibration displacement direction. A vertical coordinate represents the negative stiffness provided by the electromagnetic component 14 and the magnet component 13, and the negative stiffness is in units of N/mm.

It can be learned from FIG. 9 that, when the vibration displacement of the vibration area 122 is zero, the electromagnetic component 14 and the magnet component 13 can provide specific negative stiffness; and when the vibration displacement of the vibration area 122 increases, the negative stiffness provided by the electromagnetic component 14 and the magnet component 13 also increases.

It should be noted that, when an alternating current used to excite the vibration area 122 to vibrate is not input into the first coil 141 and the second coil 142, and the vibration area 122 generates vibration displacement, the resultant force of F1 and F2 is always less than recovery force of the folding ear 123, so that the vibration area 122 can be recovered to a location at which vibration is zero.

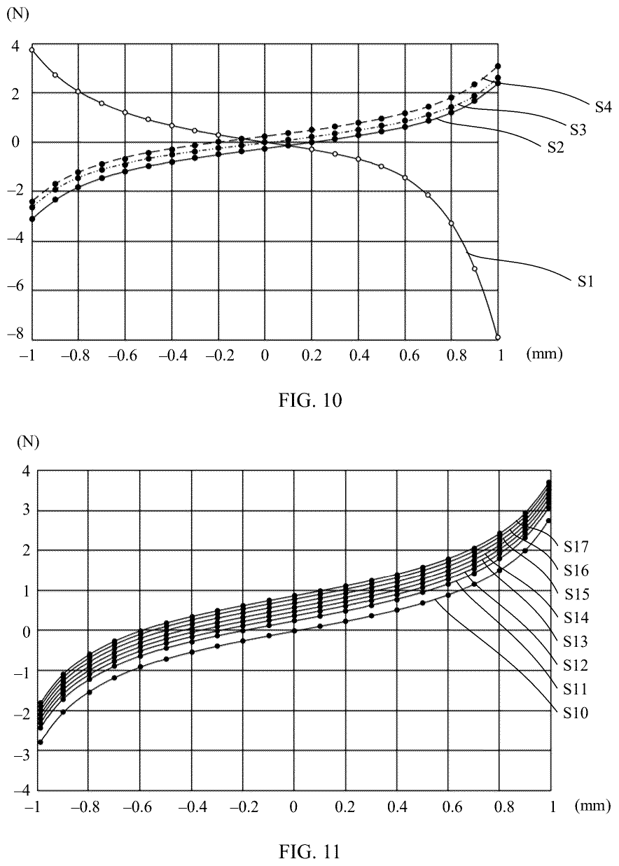

For example, as shown in FIG. 10, an embodiment of this application further provides a data diagram illustrating that force applied to the vibration area 122 varies with vibration displacement. In FIG. 10, a horizontal coordinate represents the vibration displacement of the vibration area 122, and the vibration displacement is in units of mm. When a vibration displacement value of the vibration area 122 is greater than zero, it indicates that the vibration area 122 generates vibration displacement towards the first vibration displacement direction; and when the vibration displacement value is less than zero, it indicates that the vibration area 122 generates vibration displacement towards the second vibration displacement direction. A vertical coordinate represents the force applied to the vibration area 122, and the force is in units of N. When a force value is greater than zero, a force direction is consistent with the first vibration displacement direction; and when the force value is less than zero, it indicates that the force direction is consistent with the second vibration displacement direction.

In FIG. 10, S1 represents a data curve illustrating that recovery force applied by the folding ear 123 on the vibration area 122 varies with vibration displacement.

S2 represents a data curve illustrating that magnetic attraction force applied by the electromagnetic component 14 and the magnetic attraction component to the vibration area 122 varies with vibration displacement. In this case, a current is input into neither the first coil 141 nor the second coil 142 in the electromagnetic component 14.

It can be learned from FIG. 10 that, the recovery force generated by the folding ear 123 increases as the vibration displacement of the vibration area 122 increases, and the magnetic attraction force between the electromagnetic component 14 and the magnet component 13 increases as the vibration displacement of the vibration area 122 increases. In addition, in a case of same vibration displacement, the magnetic attraction force between the electromagnetic component 14 and the magnet component 13 is less than the recovery force generated by the folding ear 123.

In addition, in some implementations, a correction current may alternatively be input into the electromagnetic component 14, and may be used to adjust magnetic field force between the electromagnetic component 14 and the magnet component 13.

For example, during specific application, some components in the speaker 10 may have a manufacturing precision error or an assembly error. Alternatively, there may be an atmospheric pressure difference between two sides of the diaphragm 12. As a result, when the vibration displacement of the vibration area 122 is zero, resultant force generated by the first magnetic core 143 and the second magnetic core 144 for the magnet component 13 is not zero, and the folding ear 123 is elastically deformed. When the diaphragm 12 is excited to generate vibration, a problem of force imbalance occurs between the first vibration displacement direction and the second vibration displacement direction, affecting sound quality performance of the speaker 10.

Therefore, a correction current may be input into the electromagnetic component 14. Specifically, the correction current may be a direct current. After the correction current is input into the electromagnetic component 14, a correction magnetic field can be generated.

Still refer to FIG. 10. S3 in FIG. 10 represents a data curve illustrating that magnetic attraction force applied by the electromagnetic component 14 and the magnet component 13 to the vibration area 122 varies with vibration displacement after a direct current of 0.5 ampere is input into both the first coil 141 and the second coil 142 in the electromagnetic component 14, and S4 represents a data curve illustrating that magnetic attraction force applied by the electromagnetic component 14 and the magnet component 13 to the vibration area 122 varies with vibration displacement after a direct current of −0.5 ampere is input into the first coil 141 and the second coil 142 in the electromagnetic component 14.

It can be learned from comparison between S2 and S3 that, the magnetic attraction force of the electromagnetic component 14 and the magnet component 13 increases towards the first vibration displacement direction as a whole. It can be learned from comparison between S2 and S4 that, the magnetic attraction force of the electromagnetic component 14 and the magnet component 13 increases towards the second vibration displacement direction.

In actual application, when the folding ear 123 is elastically deformed due to a defective case such as a manufacturing precision error, an assembly error, or an atmospheric pressure difference exists in the speaker 10, a correction current may be input into the electromagnetic component 14, to adjust magnetic force between the electromagnetic component 14 and the magnet component 13. In this way, when the vibration displacement of the vibration area 122 is zero, the folding ear 123 is not elastically deformed, to ensure that when the diaphragm 12 is excited to generate vibration, recovery force provided by the folding ear 123 in the first vibration displacement direction is consistent with that provided in the second vibration displacement direction.

Certainly, a correction current may alternatively be input only into the first coil 141, or a correction current may be input only into the second coil 142. Details are not described herein.

In addition, FIG. 11 further provides a data diagram illustrating that measured acting force applied by the electromagnetic component 14 and the magnet component 13 to the vibration area 122 varies with vibration displacement of the vibration area 122 in a case of different input power of the electromagnetic component 14. In FIG. 11, a horizontal coordinate represents the vibration displacement of the vibration area 122, and the vibration displacement is in units of mm. When the vibration displacement is greater than zero, it indicates that the vibration area 122 generates vibration displacement towards the first vibration displacement direction; and when the vibration displacement is less than zero, it indicates that the vibration area 122 generates vibration displacement towards the second vibration displacement direction. A vertical coordinate represents the magnetic attraction force applied by the electromagnetic component 14 and the magnetic attraction component to the vibration area 122, and the magnetic attraction force is in units of N.

Specifically, S10 represents a data curve illustrating that magnetic attraction force applied by the electromagnetic component 14 and the magnetic attraction component to the vibration area 122 varies with vibration displacement when input power of the electromagnetic component is zero.

S11 represents a data curve illustrating that magnetic attraction force applied by the electromagnetic component 14 and the magnetic attraction component to the vibration area 122 varies with vibration displacement when input power of the electromagnetic component is 1 watt (W).

S12 represents a data curve illustrating that magnetic attraction force applied by the electromagnetic component 14 and the magnetic attraction component to the vibration area 122 varies with vibration displacement when input power of the electromagnetic component is 2 watts (W).

S13 represents a data curve illustrating that magnetic attraction force applied by the electromagnetic component 14 and the magnetic attraction component to the vibration area 122 varies with vibration displacement when input power of the electromagnetic component is 3 watts (W).

S14 represents a data curve illustrating that magnetic attraction force applied by the electromagnetic component 14 and the magnetic attraction component to the vibration area 122 varies with vibration displacement when input power of the electromagnetic component is 4 watts (W).

S15 represents a data curve illustrating that magnetic attraction force applied by the electromagnetic component 14 and the magnetic attraction component to the vibration area 122 varies with vibration displacement when input power of the electromagnetic component is 5 watts (W).

S16 represents a data curve illustrating that magnetic attraction force applied by the electromagnetic component 14 and the magnetic attraction component to the vibration area 122 varies with vibration displacement when input power of the electromagnetic component is 6 watts (W).

S17 represents a data curve illustrating that magnetic attraction force applied by the electromagnetic component 14 and the magnetic attraction component to the vibration area 122 varies with vibration displacement when input power of the electromagnetic component is 7 watts (W).

During specific application, a specific magnitude of the correction current may be set before delivery of the speaker 10. For example, before delivery, a manufacturer may perform force detection or debugging on the magnet component 13 or the folding ear 123, to ensure that magnetic force between the electromagnetic component 14 and the magnet component 13 is zero (or the folding ear 123 is not elastically deformed). Alternatively, in some implementations, a detection device may be disposed in the speaker 10. During use (after delivery) of the speaker 10, force detection may be performed on a component such as the folding ear 123, to ensure that magnetic force between the electromagnetic component 14 and the magnet component 13 is zero. During specific implementation, a specific type and a detection manner of the detection device may be properly set based on an actual requirement. This is not limited in this application.

During specific disposing, the first magnetic core 143 and the first coil 141 may be in various shapes.

For example, as shown in FIG. 5 and FIG. 7, in an example provided in this application, the first magnetic core 143 includes a first inner core 1431 and a first outer core 1432. The first inner core 1431 is located in an inner ring of the first coil 141, and the first outer core 1432 is located in an outer ring of the first coil 141. When there is a current in the first coil 141, a structure including the first coil 141, the first inner core 1431, and the first outer core 1432 can generate a large magnetic field. Specifically, the first coil 141 is of a circular ring-shaped structure, the first inner core 1431 is in a circular sheet shape, and the first outer core 1432 is in a circular ring shape. There is a small gap between the first coil 141 and each of the first inner core 1431 and the first outer core 1432, so that structures of the first coil 141, the first inner core 1431, and the first outer core 1432 are compact, thereby reducing space occupation.

It may be understood that, in another example, the first coil 141 may be an elliptical ring, the first inner core 1431 may be an elliptical sheet, and the first outer core 1432 may be in a shape such as an elliptical ring. Specific shapes of the first coil 141, the first inner core 1431, and the first outer core 1432 are not limited in this application.

Certainly, in another example, disposing of the first inner core 1431 or the first outer core 1432 may alternatively be omitted. Details are not described herein.

In addition, during specific disposing, the second magnetic core 144 may include a second inner core 1441 and a second outer core 1442, the second inner core 1441 may be located in an inner ring of the second coil 142, and the second outer core 1442 is located in an outer ring of the second coil 142.

In specific application, the first coil 141 and the second coil 142 may be the same or approximately the same, and the second magnetic core 144 and the first magnetic core 143 may be the same or approximately the same. Details are not described herein.

In addition, when the coil and the magnetic core are specifically disposed, the coil and the magnetic core may be located on a same plane, and the plane may be parallel to the diaphragm, so that a height size of a structure including the coil and the magnetic core can be effectively reduced, thereby helping reducing a height size of the entire speaker 10. For example, the first coil 141 and the first magnetic core 143 are used as an example. The first coil 141 and the first magnetic core 143 are located on a same plane. The same plane is an approximate plane, and the plane may have a specific thickness. This specifically means that in a direction perpendicular to the plane, the first coil 141 and the first magnetic core 143 do not have an obvious protruding structure or a large size. When the first coil 141 and the first magnetic core 143 are located on a same plane, a height size of a structure including the first coil 141 and the first magnetic core 143 is small, so that space occupation in a vibration displacement direction of the vibration area 122 can be reduced, thereby helping reduce the height size of the speaker 10. Alternatively, it may be understood that, in a case of a same amplitude of the vibration area 122, after the first coil 141 and the first magnetic core 143 are disposed on a same plane, the height size of the speaker 10 can be effectively reduced.

For the magnet component 13, during specific application, the magnet component 13 may be a permanent magnet.

Specifically, as shown in FIG. 7, in an example provided in this application, the magnet component 13 is a circular ring-shaped permanent magnet. A pole direction of the magnet component 13 is consistent with a radial direction. Alternatively, it may be understood that an N pole of the magnet component 13 may be located in an inner ring of a circular ring shape, and an S pole is located in an outer ring; or the N pole is located in the inner ring, and the S pole is located in the inner ring.

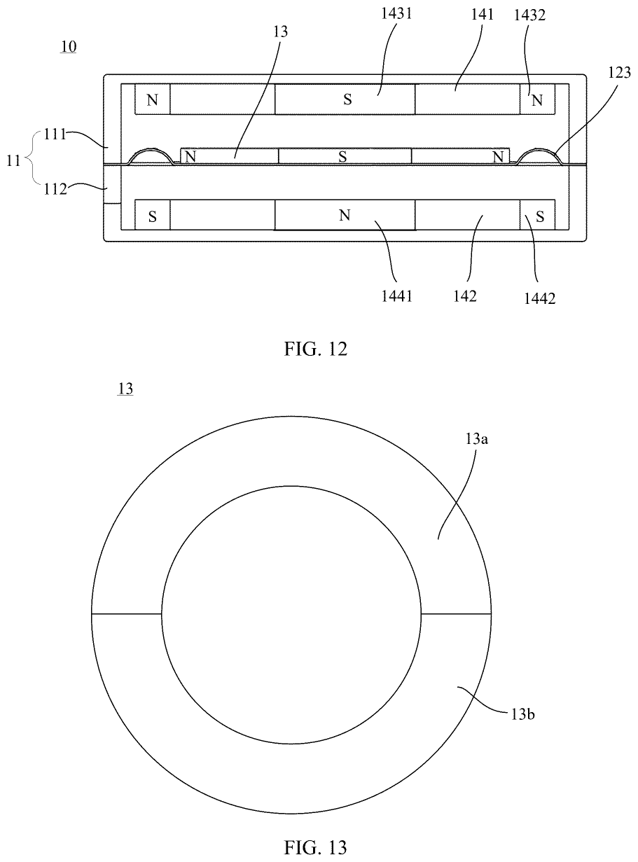

For example, as shown in FIG. 12, in an example provided in this application, the N pole of the magnet component 13 is located in the outer ring, and the S pole is located in the inner ring.

After a current is input into the first coil 141 and the second coil 142, a pole direction of a structure including the first coil 141, the first inner core 1431, and the first outer core 1432 is shown in FIG. 12, to be specific, the S pole is located at the first inner core 1431, and the N pole is located at the first outer core 1432. A pole direction of a structure including the second coil 142, the second inner core 1441, and the second outer core 1442 is shown in FIG. 12, to be specific, the N pole is located at the first inner core 1431, and the S pole is located at the first outer core 1432. It can be learned from “like poles repel each other and unlike poles attract each other”, in this case, magnetic field force applied to the magnet component 13 faces the second coil 142.

After the pole direction and the radial direction of the magnet component 13 are consistent, it is helpful to improve stability of magnetic force between the magnet component 13 and the electromagnetic component 14. Certainly, in another example, a shape of the magnet component 13 may alternatively be a strip shape, a circular sheet shape, an elliptical ring shape, or the like. Details are not described herein.

In addition, the magnet component 13 may be one permanent magnet, or may include a plurality of permanent magnets.

For example, as shown in FIG. 13, in an example provided in this application, the magnet component 13 may include two permanent magnets, and the two permanent magnets are respectively a permanent magnet a and a permanent magnet b. The permanent magnet a and the permanent magnet b each are in a semi-circular ring shape, and the permanent magnet a and the permanent magnet b may form a circular ring shape. During specific application, the permanent magnet a and the permanent magnet b may be fixedly connected in a manner such as bonding.

In addition, in another example, the magnet component 13 may include three or more permanent magnets. A quantity of permanent magnets and a shape of the permanent magnet are not limited in this application.

It should be noted that, in the example shown in FIG. 12, the magnet component 13 may be fastened on a surface of the vibration area 122, and the electromagnetic component 14 may be fastened in the housing 11. In another example, locations of the magnet component 13 and the electromagnetic component 14 may alternatively be interchanged.

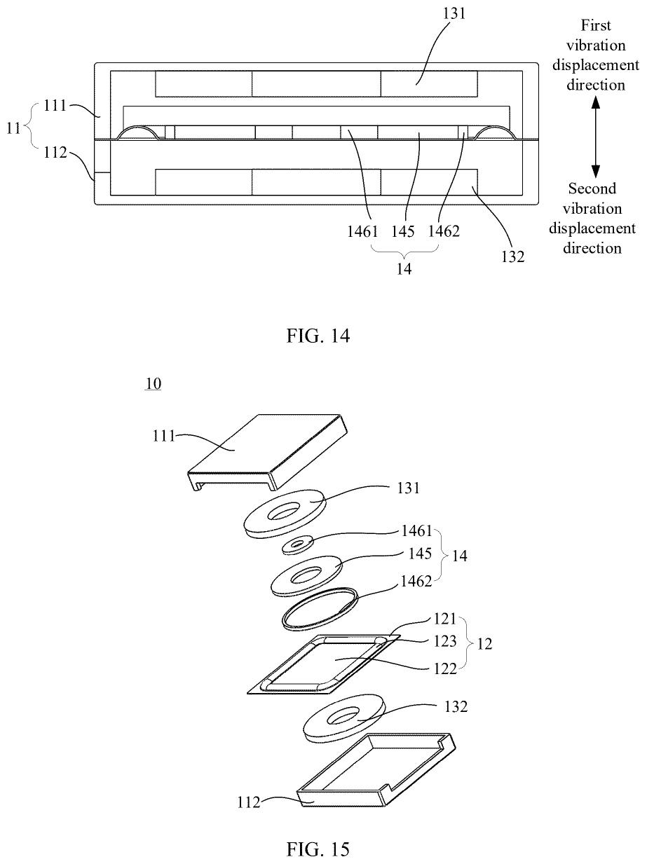

For example, as shown in FIG. 14 and FIG. 15, in an example provided in this application, the electromagnetic component 14 may be fastened on the surface of the vibration area 122, and the magnet component may be fastened in the housing 11, to help reduce a height size (that is, a size in a vibration displacement direction parallel to the vibration area 122) of a structure including the electromagnetic component 14 and the diaphragm 12. Specifically, the magnetic field generated by the electromagnetic component 14 not only can cover the diaphragm 12, but also can store effective magnetic field strength in the first vibration displacement direction or the second vibration displacement direction, thereby helping reduce a height size of the electromagnetic component 14. Alternatively, it may be understood that, if a coil 145 in the electromagnetic component 14 is not disposed on a surface of the diaphragm 12, the coil 145 needs to extend into a magnetic gap of the magnet component (for example, a first permanent magnet 131 in FIG. 14), and the coil 145 needs to be always in the magnetic gap in an amplitude range of the vibration area 122. If the coil 145 is not in the magnetic gap, Lorentz force between the coil 145 and the first permanent magnet 131 fails, and the vibration area 122 cannot be effectively driven to vibrate to produce a sound. Therefore, the electromagnetic component 14 is fastened on the surface of the vibration area 122, and the magnet component is fastened in the housing 11, thereby helping reduce the height size of the structure including the electromagnetic component 14 and the diaphragm 12.

Specifically, as shown in FIG. 14 and FIG. 15, the magnet component 13 may include the first permanent magnet 131 and a second permanent magnet 132. The first permanent magnet 131 is located in the first vibration displacement direction of the vibration area 122, and the second permanent magnet 132 is located in the second vibration displacement direction of the vibration area 122. The electromagnetic component 14 includes the coil 145 and a magnetic core 146 disposed in a magnetic circuit of the coil 145. The magnetic core 146 includes an inner core 1461 and an outer core 1462. The inner core 1461 is located in an inner ring of the coil 145, and the outer core 1462 is located in an outer ring of the coil 145.

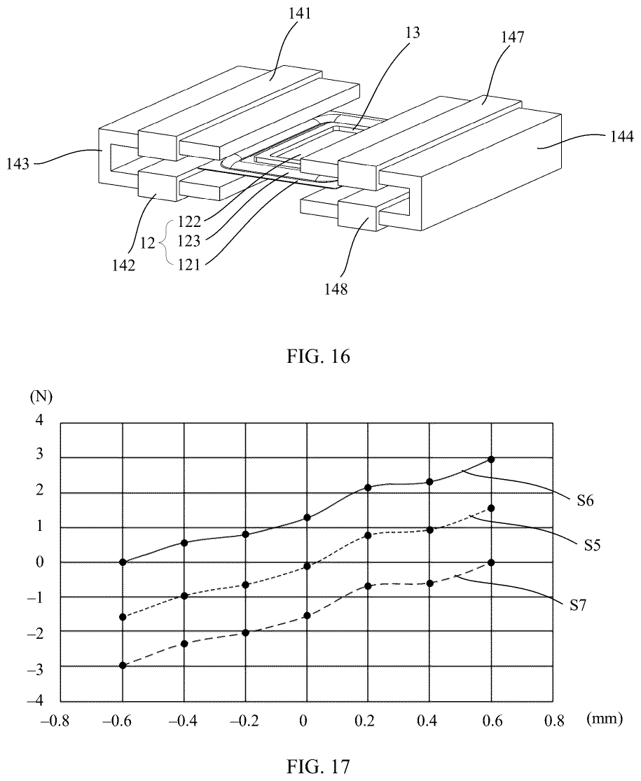

In addition, as shown in FIG. 16, in another example provided in this application, the magnetic core may include a first magnetic core 143 and a second magnetic core 144, and the coil includes a first coil 141, a second coil 142, a third coil 147, and a fourth coil 148.

Specifically, the magnet component 13 is a ring-shaped permanent magnet, the first magnetic core 143 is U-shaped, and the first coil 141 and the second coil 142 are respectively wound on two opposite cantilevers of the first magnetic core 143. The second magnetic core 144 is U-shaped, and the third coil 147 and the fourth coil 148 are respectively wound on two opposite cantilevers of the second magnetic core 144. The first magnetic core 143 is located on a first side edge (for example, a left side in FIG. 16) of the diaphragm 12, and the second magnetic core 144 is located on a second side edge (for example, a right side in FIG. 16) of the diaphragm 12. The first side edge and the second side edge are away from each other, and U-shaped openings of the first magnetic core 143 and the second magnetic core 144 are disposed opposite to each other, thereby helping reduce a height size of the speaker 10.

During specific disposing, projections of the first coil 141, the second coil 142, the third coil 147, and the fourth coil 148 on a plane on which the diaphragm 12 is located do not overlap the diaphragm 12, thereby helping ensure maximum vibration displacement of the diaphragm 12. Alternatively, it may be understood that, the first coil 141, the second coil 142, the third coil 147, and the fourth coil 148 do not occupy vibration displacement space of the vibration area 122. Therefore, a distance between the two opposite cantilevers of the first magnetic core 143 may be set to be small, and correspondingly, a distance between the two opposite cantilevers of the second magnetic core 144 may be set to be small, thereby helping reduce the height size of the speaker 10. In addition, there is also good magnetic attraction force between the electromagnetic component 14 and the magnet component 13.

For example, as shown in FIG. 17, an embodiment of this application further provides a data diagram illustrating that acting force applied by the electromagnetic component 14 and the magnet component 13 to the vibration area 122 varies with vibration displacement of the vibration area 122. In FIG. 17, a horizontal coordinate represents the vibration displacement of the vibration area 122, and the vibration displacement is in units of mm. When the vibration displacement is greater than zero, it indicates that the vibration area 122 generates vibration displacement towards the first vibration displacement direction; and when the vibration displacement is less than zero, it indicates that the vibration area 122 generates vibration displacement towards the second vibration displacement direction. A vertical coordinate represents the magnetic attraction force applied by the electromagnetic component 14 and the magnetic attraction component to the vibration area 122, and the magnetic attraction force is in units of N.

Specifically, S5 represents a data curve illustrating that magnetic attraction force applied by the electromagnetic component 14 and the magnetic attraction component to the vibration area 122 varies with vibration displacement. In this case, no current is input into the electromagnetic component 14.

In FIG. 17, S6 represents a data curve illustrating that magnetic attraction force applied by the electromagnetic component 14 and the magnetic attraction component to the vibration area 122 varies with vibration displacement after a direct current of 1.4 ampere is input into the electromagnetic component 14; and S7 represents a data curve illustrating that magnetic attraction force applied by the electromagnetic component 14 and the magnetic attraction component to the vibration area 122 varies with vibration displacement after a direct current of −1.4 ampere is input into the electromagnetic component 14. It can be learned from FIG. 17 that, there is good magnetic attraction force between the electromagnetic component 14 and the magnet component 13.

During specific application, the speaker 10 may further include a control circuit, and the control circuit is in signal connection to the electromagnetic component 14, to effectively control a current in the electromagnetic component 14. It should be noted that, the current may be a correction current, may be an alternating current used to enable the diaphragm 12 vibrate to produce a sound, or may be superposition of a correction current and an alternating current.

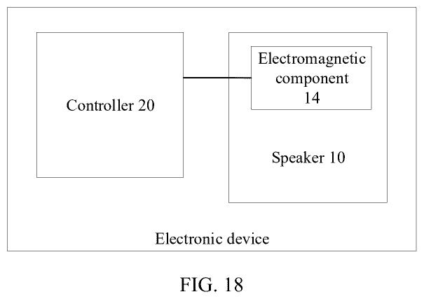

Alternatively, when the speaker 10 is used in an electronic device such as a mobile phone, a tablet computer, or a sound box, as shown in FIG. 18, a controller 20 in the electronic device may be in signal connection to the electromagnetic component 14, to effectively control a current that is input into the electromagnetic component 14. Details are not described herein.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An electronic device comprising a controller and a speaker, wherein the speaker comprises:
a housing wherein an accommodating cavity is defined;
a diaphragm, disposed in the accommodating cavity, wherein the diaphragm comprises a fastening area and a vibration area, and the fastening area is fixedly connected to the housing; and
a magnet component and an electromagnetic component that magnetically attract each other, wherein:
the magnet component is fastened in the vibration area, and the electromagnetic component is fastened in the housing;
an acting force applied by the magnet component and the electromagnetic component to the vibration area is zero when the vibration area is at an initial location;
the acting force applied by the magnet component and the electromagnetic component to the vibration area is the same as a vibration displacement direction of the vibration area when the vibration area vibrates; and
the vibration displacement direction is a direction in which the initial location of the vibration area points to a vibration location of the vibration area.

2. The electronic device according to claim 1, wherein the magnet component is a permanent magnet, the electromagnetic component comprises a coil and a magnetic core, and the magnetic core is located in a magnetic circuit of the coil.

3. The electronic device according to claim 2, wherein when the vibration area is at the initial location, a sum of magnetic force between the magnet component and the magnetic core is zero.

4. The electronic device according to claim 2, wherein there is a correction current in the coil, and when the vibration area is at the initial location, a sum of magnetic force between the electromagnetic component and the magnet component is zero.

5. The electronic device according to claim 2, wherein
the coil comprises a first coil and a second coil, the magnetic core comprises a first magnetic core and a second magnetic core, the first magnetic core is located in a magnetic circuit of the first coil, and the second magnetic core is located in a magnetic circuit of the second coil;
the first coil and the first magnetic core are located in a first vibration displacement direction of the vibration area;
the second coil and the second magnetic core are located in a second vibration displacement direction of the vibration area; and
the first vibration displacement direction is opposite to the second vibration displacement direction.

6. The electronic device according to claim 5, wherein the first magnetic core comprises a first inner core and a first outer core, the first inner core is located in an inner ring of the first coil, and the first outer core is located in an outer ring of the first coil; and
the second magnetic core comprises a second inner core and a second outer core, the second inner core is located in an inner ring of the second coil, and the second outer core is located in an outer ring of the second coil.

7. The electronic device according to claim 2, wherein the coil and the magnetic core are located on a same plane, and the plane is parallel to the diaphragm.

8. The electronic device according to claim 2, wherein
the magnet component is fastened in the vibration area, and the electromagnetic component is fastened in the housing;
the magnetic core comprises a first magnetic core and a second magnetic core, and the coil comprises a first coil, a second coil, a third coil, and a fourth coil;
the first magnetic core is U-shaped, and the first coil and the second coil are respectively wound on two opposite cantilevers of the first magnetic core;
the second magnetic core is U-shaped, and the third coil and the fourth coil are respectively wound on two opposite cantilevers of the second magnetic core;
the first magnetic core is located on a first side edge of the diaphragm, and the second magnetic core is located on a second side edge of the diaphragm; and
the first side edge and the second side edge are on opposite sides of the diaphragm, and U-shaped openings of the first magnetic core and the second magnetic core are disposed opposite to each other.

9. The electronic device according to claim 8, wherein projections of the first coil, the second coil, the third coil, and the fourth coil on a plane on which the diaphragm is located do not overlap the diaphragm.

10. The electronic device according to claim 1, wherein a shape of the magnet component is a ring shape, and a pole direction of the magnet component is in a radial direction of the magnet component.

11. The electronic device according to claim 1, wherein the magnet component comprises at least two permanent magnets.

12. The electronic device according to claim 1, further comprising a control circuit, wherein the control circuit is in signal connection with the electromagnetic component.

13. An electronic device comprising a controller and a speaker, wherein the speaker comprises:
a housing wherein an accommodating cavity is defined;
a diaphragm, disposed in the accommodating cavity, wherein the diaphragm comprises a fastening area and a vibration area, and the fastening area is fixedly connected to the housing; and
a magnet component and an electromagnetic component that magnetically attract each other, wherein:
the magnet component is fastened in the housing, and the electromagnetic component is fastened in the vibration area;
an acting force applied by the magnet component and the electromagnetic component to the vibration area is zero when the vibration area is at an initial location;
the acting force applied by the magnet component and the electromagnetic component to the vibration area is the same as a vibration displacement direction of the vibration area when the vibration area vibrates; and
the vibration displacement direction is a direction in which the initial location of the vibration area points to a vibration location of the vibration area.

14. The electronic device according to claim 13, wherein the magnet component is a permanent magnet, the electromagnetic component comprises a coil and a magnetic core, and the magnetic core is located in a magnetic circuit of the coil.

15. The electronic device according to claim 14, wherein when the vibration area is at the initial location, a sum of magnetic force between the magnet component and the magnetic core is zero.

16. The electronic device according to claim 14, wherein there is a correction current in the coil, and when the vibration area is at the initial location, a sum of magnetic force between the electromagnetic component and the magnet component is zero.

17. The electronic device according to claim 13, wherein
the magnet component comprises a first permanent magnet and a second permanent magnet;
the first permanent magnet is located in a first vibration displacement direction of the vibration area;
the second permanent magnet is located in a second vibration displacement direction of the vibration area; and
the first vibration displacement direction is opposite to the second vibration displacement direction.

18. The electronic device according to claim 14, wherein the coil and the magnetic core are located on a same plane, and the plane is parallel to the diaphragm.

19. The electronic device according to claim 14, wherein
the magnet component comprises a first permanent magnet and a second permanent magnet;
the first permanent magnet is located in a first vibration displacement direction of the vibration area;
the second permanent magnet is located in a second vibration displacement direction of the vibration area; and
the first vibration displacement direction is opposite to the second vibration displacement direction.

20. The electronic device according to claim 15, wherein the coil and the magnetic core are located on a same plane, and the plane is parallel to the diaphragm.
